(19) United States
(12) Patent Application Publication
(10) Pub. No.: US 2007/0217317 A1
(43) Pub. Date: Sep. 20, 2007

(54) Optical disk device, playback method of the optical disk device, and reproduction signal generating circuit

(75) Inventor: Akihiro Saito, Tsuruoka-Shi (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/712,431

(22) Filed: Mar. 1, 2007

(30) Foreign Application Priority Data
Mar. 20, 2006 (JP) 2006-076568

(51) Int. Cl. G11B 7/00

(52) U.S. Cl. 369/124.01; 369/124.07

(57) ABSTRACT

An optical disk device according to an embodiment of the present invention includes: an irradiating unit irradiating an optical disk with laser light; a photodetector split into at least two along a track direction of the optical disk and converting return light from the optical disk into an electric signal to output a detection signal; and a reproduction signal generating unit generating an RF signal based on the detection signal from the photodetector. The reproduction signal generating unit generates an RF signal in a header portion based on a detection signal from one of the at least two photodetectors split along the track direction or a detection signal from the other photodetector. An RF signal in a data portion is generated based on all of detection signals from the photodetector.

### BACKGROUND OF THE INVENTION

1. Field of the Invention

The present invention relates to a reproduction signal generating circuit compatible with DVD (Digital Versatile Disk)-RAM, a disk device, and a playback method of the disk device. In particular, the invention relates to a reproduction signal generating circuit for suppressing an influence of a crosstalk signal from an adjacent track, a disk device incorporating the reproduction signal generating circuit, and a playback method of the disk device.

2. Description of Related Art

Along with developments in recent optical disk technology, a variety of optical media compliant with the technology have been produced. To that end, optical disk devices need to be super-multi-disk drive devices compliant with all of DVD±R, RW, and DVD-RAM. A key problem is how to improve an error rate upon recording and reproducing data on a DVD-RAM medium among the media.

As for specification of the DVD-RAM, the DVD-RAM enables high-density recording with a recording capacity of about 2.6 GB on one side (5.2 GB on both sides) or 4.7 GB on one side (9.4 GB on both sides). To realize such high recording density, a mark edge recording method suitable to improve line density in recording and a land/groove recording method suitable to reduce a track pitch. According to the land/groove recording method, data is recorded not only in a groove but also in a land portion between grooves for increasing recording density.

FIG. 7 is a schematic diagram showing a DVD-RAM format. Address signals are recorded on a sector basis as a PID (Physical ID) by a CAPA (Complimentary Allocated Pit Addressing) method. The CAPA is a method of forming pits for recording the PID ½-track apart from a data recording track (land or groove). An address in groove tracking is obtained from a CAPA signal of a PID subsequent to a target track, and an address in land tracking is obtained from a CAPA signal of a PID previous to a target track.

In each zone, a disk is driven at CAV, so CAPA signals are arranged in a radius direction. Further, a data recording portion between CAPA signals (land or groove) is wobbled. The number of wobbles is counted to thereby measure exact position of the next CAPA pit.

A sector is composed of a CAPA portion recording an address and a data recording portion which is a land or a groove. 16 data portions of the sector constitute 1 error correction block and execute error correction.

Next, how to obtain address information with a general DVD-RAM is described (for example, see Japanese Unexamined Patent Application Publication No. 2005-85326). As described above, 1 sector is composed of a header portion and a data portion. In the header portion, ID1 and ID2, ID3, and ID4 are formed in embossed pits. Any one of the address information ID1 to ID4 is reproduced to thereby obtain address information of the sector. The address information ID1 and ID2 are formed on the same position in a circumferential direction, and the address information ID3 and ID4 are also formed on the same position in the circumferential direction. Further, the address information ID1 and ID2 and the address information ID3 and ID4 are positioned apart from each other in a radius direction of an optical disk.

As shown in FIG. 8, if a spot of laser light from an optical pickup moves to the right on the paper, first, the address information ID1 and ID2 are detected and the subsequent address information ID3 and ID4 are detected. In the DVD-RAM, data is recoded on both of the land and groove for increasing recording density. Regarding the land, the address information ID1 and ID2 are recoded on an inner circumferential side of the disk, and the address information ID3 and ID4 are recoded on an outer circumferential side of the disk. Regarding the groove, the ID1 and ID2 are recoded on an outer circumferential side of the disk, and the address information ID3 and ID4 are recoded on an inner circumferential side of the disk. Accordingly, an address information position differs between the land and groove. Based on such positional difference, the optical disk device can distinguish the land from the groove.

FIG. 8 also shows a 4-split photodetector 1 for converting return light to an electric signal. The 4-split photodetector 1 is composed of four A to D photodetectors Da to Dd. The split photodetectors are grouped into (Da+Dd) and (Db+Dc) along a track direction. In on-track condition, the photodetectors (Da+Dd) detects ID1 and ID2 and the photodetectors (Db+Dc) detect ID3 and ID4 at the land. The photodetectors (Da+Dd) detect ID3 and ID4 and the photodetectors (Db+Dc) detect ID1 and ID2 at the groove.

FIG. 9 shows an RF signal generating circuit for generating an RF signal by means of the 4-split photodetector 1. FIG. 10 is a schematic diagram showing an RF signal output from the RF signal generating circuit. The RF signal generating circuit 200 includes a MIXAMP 201 having a positive terminal (noninverting input terminal) which receives a reference voltage Ref and having a negative terminal (inverting input terminal) which receives detection signals Sa to Sd from the 4-split photodetector 1, a gain-controlled amplifier GCA 202, and an amplifier unit 203. The RF signal is output from an output RFOUT after the MIXAMP 201 synthesizes the detection signals Sa to Sd from the 4-split photodetector 1 and the GCA 202 and the amplifier unit 203 control a gain as appropriate. As shown in FIG. 10, the RF signal sent from the output is (Sa+Sb+Sc+Sd) as the sum of the signals from the 4-split photodetectors Da, Db, Dc, and Dd in the data portion and the header portion.

As shown in FIGS. 8 and 9, the RF signal is output as the sum of the detection signals Sa to Sd from the 4-split photodetector 1. However, as shown in FIG. 7, in on-track condition, the photodetectors (Da+Dd) detect the address information ID1 and ID2 and the photodetectors (Db+Dc) detect the address information ID3 and ID4 in a land portion. Here, if the photodetectors (Da+Dd) are positioned on the address information ID1 and ID2, the photodetectors (Db+Dc) trace a MIRR surface. Further, the photodetectors (Db+Dc) are positioned on the address information ID3 and ID4, the photodetectors (Da+Dd) trace the MIRR surface.

As a result of tracing the MIRR surface this way, photodetectors tracing the MIRR surface receives an unintended crosstalk signal from an adjacent track. Here, the crosstalk signal from the adjacent track is mixed such that as shown in FIG. 8, during reproduction of the address information ID1 and ID2 of a land track from the photodetectors Da and Dd of the photodetector 1, for example, the photodetectors Db and Dc reproduce the address information ID1 and ID2 having the same position in the radius direction at an adjacent groove track. That is, a signal composed of signals from two photodetectors split along the track direction of the 4-split photodetector 1 contains larger noise components in a header portion due to a crosstalk signal from an adjacent track. Therefore, noise is superimposed on an RF signal of a header portion of FIG. 10, resulting in a problem of higher error rate.

### SUMMARY OF THE INVENTION

An optical disk device according to an aspect of the present invention includes: an irradiating unit irradiating an optical disk with laser light; a photodetector split into at least two along a track direction of the optical disk and converting return light from the optical disk into an electric signal to output a detection signal; and a reproduction signal generating unit generating the reproduction signal by selectively using a part or all of detection signals from the photodetector in accordance with a reproduction area.

According to the present invention, the reproduction signal is generated based on all or a part of detection signals from the photodetector in accordance with a reproduction area. Hence, detection signals in an unnecessary area are not used as the reproduction signal.

A playback method of an optical disk device according to an aspect of the present invention includes: irradiating an optical disk with laser light; converting return light from the optical disk into an electric signal to output a detection signal by a photodetector split into at least two along a track direction; and generating the reproduction signal by selectively using a part or all of detection signals from the photodetector in accordance with a reproduction area.

According to the present invention, the reproduction signal is generated based on all or a part of detection signals from the photodetector in accordance with a reproduction area. Hence, detection signals in an unnecessary area are not used as the reproduction signal.

According to the present invention, it is possible to provide a reproduction signal generating circuit capable of preventing noise from being superimposed on a reproduction signal and increasing an error rate, an optical disk device incorporating the reproduction signal generating circuit, and a playback method of the optical disk device.

### BRIEF DESCRIPTION OF THE DRAWINGS

The above and other objects, advantages and features of the present invention will be more apparent from the following description taken in conjunction with the accompanying drawings, in which:

FIG. 1 shows the partial configuration of an optical disk device according to an embodiment of the present invention;

FIG. 2 is a block diagram of an RF signal generating circuit according to the embodiment of the present invention;

FIG. 3 shows a specific example of a control circuit in the RF signal generating circuit according to the embodiment of the present invention;

FIG. 4 shows a control signal of the control circuit in the RF signal generating circuit according to the embodiment of the present invention;

FIG. 5 illustrates a detection signal selectively output from the control circuit in the RF signal generating circuit according to the embodiment of the present invention;

FIG. 6 schematically shows an RF signal generated with the RF signal generating circuit according to the embodiment of the present invention;

FIG. 7 is a schematic diagram showing a DVD-RAM format;

FIG. 8 is a schematic diagram showing a sector configuration of the DVD-RAM;

FIG. 9 shows a conventional RF signal generating circuit for generating an RF signal with a 4-split photodetector; and

FIG. 10 is a schematic diagram showing an RF signal output from the conventional RF signal generating circuit.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

The following embodiment is accomplished by applying the present invention to a DVD-RAM-compatible optical disk device.

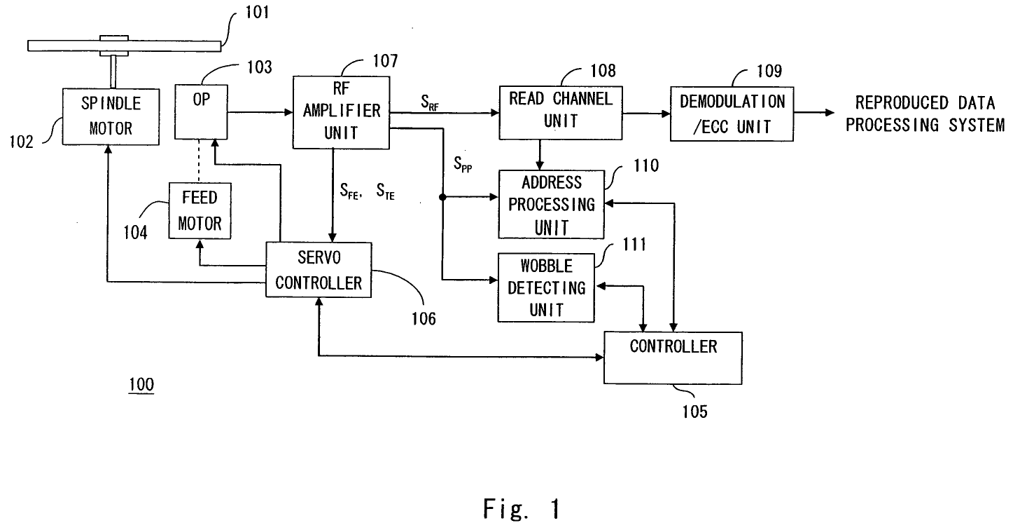

First, the optical disk device is outlined. FIG. 1 shows the partial configuration of an optical disk device according to the embodiment of the present invention. An optical disk device 100 includes a spindle motor 102, an optical pickup 103, and a feed motor 104. The spindle motor 102 rotates the set optical disk 101. The optical pickup 103 includes a semiconductor laser, an objective lens, a photodetector, and the like. The feed motor 104 moves the optical pickup 103 in a radius direction of the optical disk 101. In this case, a laser beam emitted from the semiconductor laser of the optical pickup 103 is reflected by a recording surface of the optical disk 101, and the reflected light is detected by photodetectors constituting the optical pickup 103.

Further, the optical disk device 100 includes a controller 105 having control over a drive and a servo controller 106. The servo controller 106 controls tracking or focusing in the optical pickup 103 and controls operations of the feed motor 104. Further, the servo controller 106 controls rotation of the spindle motor 102.

Further, the optical disk device 100 includes an RF amplifier unit 107 for processing output signals of the photodetectors constituting the optical pickup 103 to generate a reproduction RF signal S_{RF}, a focus error signal S_{FE}, a tracking error signal S_{TE}, and a push-pull signal S_{PP}. Here, the focus error signal S_{FE} is generated in accordance with an astigmatic method. Then, the tracking error signal S_{TE} is generated with a D_{PD} method (phase contrast method) upon reproduction and with a push-pull method upon recording, for example.

The focus error signal S_{FE} and tracking error signal S_{TE} generated with the RF amplifier unit 107 are supplied to the servo controller 106, and the servo controller 106 controls tracking or focusing in the optical pickup 103 with these error signals.

Further, the optical disk device 100 includes a read channel unit 108 executes a series of analog signal processings; a reproduction RF signal S_{RF} generated with the RF amplifier unit 107 is sliced into binary data, followed by generation of synchronous data with a signal generating circuit (Phase-Locked Loop), and a demodulation/ECC unit 109 executing demodulation of the synchronous data generated with the read channel unit 108 and subsequent error correction. The output data of the demodulation/ECC unit 109 is supplied to a reproduced data processing circuit (not shown).

Further, the optical disk device 100 includes an address processing unit 110. The address processing unit 110 transfers address information extracted from the reproduction RF signal S_{RF} with the read channel unit 108 to the controller 105. Further, the address processing unit 110 processed the push-pull signal S_{PP} to obtain address information and transfers the address information extracted from the push-pull signal to the controller 105. Further, the optical disk device 100 includes a wobble detection unit 111 for detecting a wobble signal from the push-pull signal S_{PP} generated with the RF amplifier unit 107.

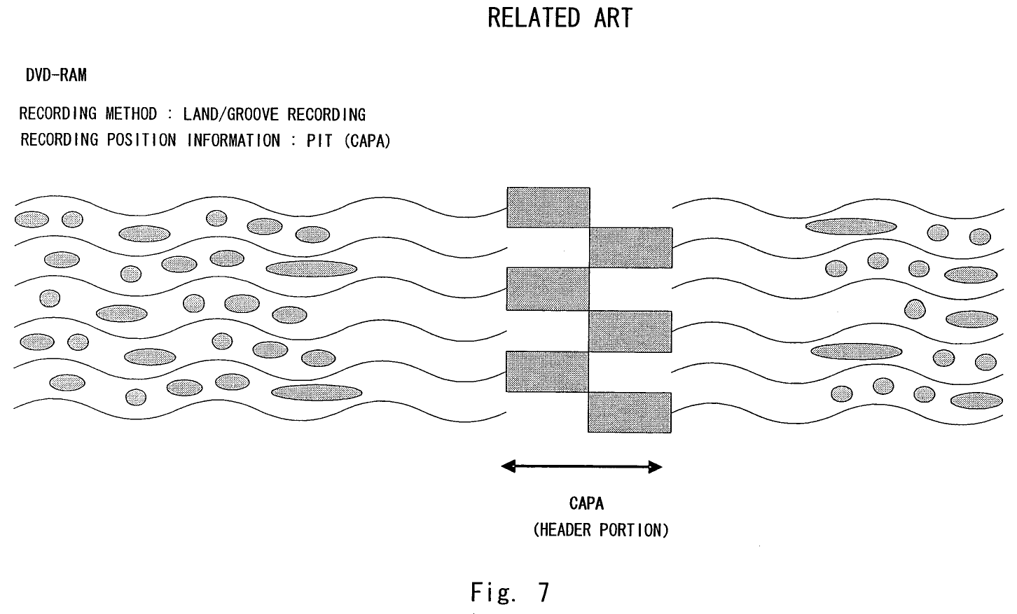

Here, as shown in FIG. 7, a 4-split photodetector 1 is used as the photodetectors constituting the optical pickup 103. A spot SP of return light from the optical disk 101 is formed on the photodetector 1. Provided that detection signals from four photodiodes Da to Dd constituting the photodetector 1 are represented by Sa to Sd, the RF signal S_{RF} is derived from S_{RF}=Sa+Sb+Sc+Sd.

Next, an RF amplifier unit (hereinafter referred to as “RF signal generating circuit”) in the thus-configured optical disk playback device according to this embodiment is described. In this embodiment, address information upon reproduction is selectively used to thereby obtain an RF signal S_{RF} of the address information that is less influenced by a crosstalk signal from an adjacent track to increase an error rate.

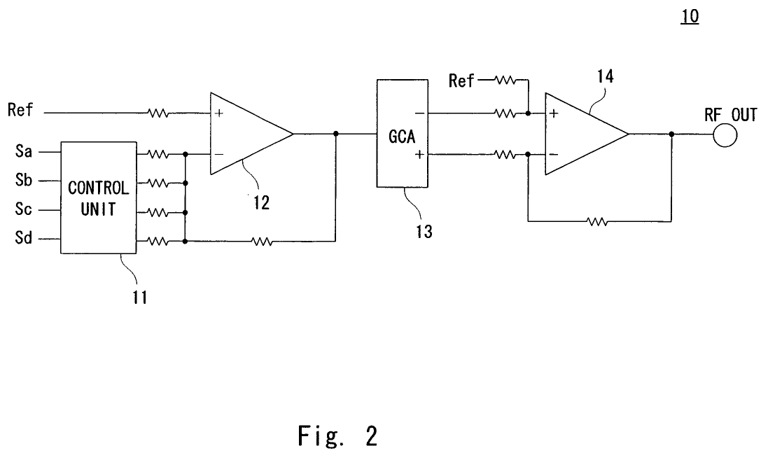

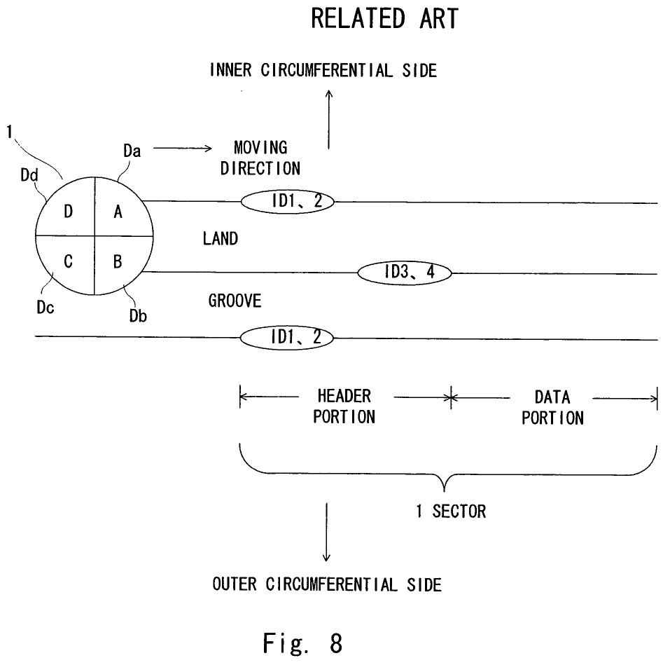

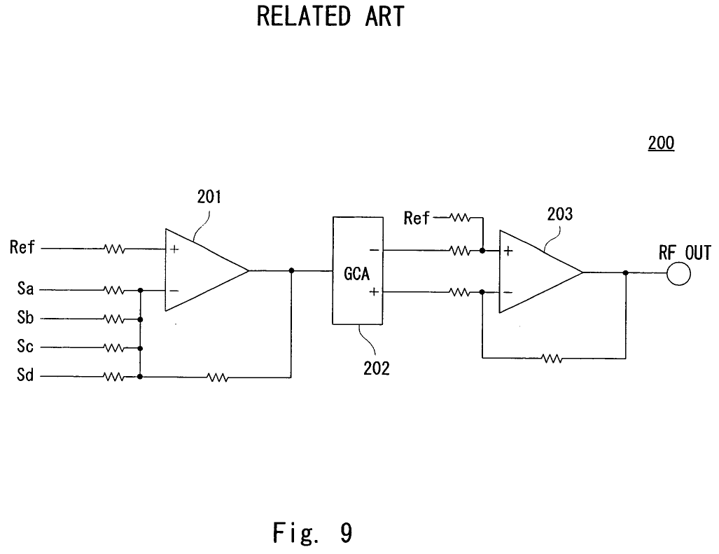

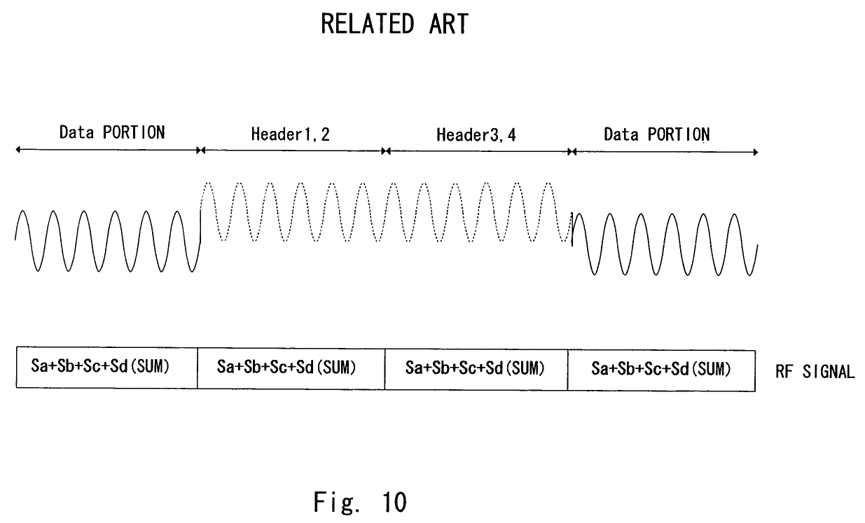

FIG. 2 is a block diagram of the RF signal generating circuit of this embodiment. An RF signal generating circuit 10 includes a control circuit 11, a MIXAMP 12, a GCA 13, and an amplifier 14. This configuration additionally includes a control circuit 11 on the upstream side of a MIXAMP of a conventional processing circuit as shown in FIG. 8. The control circuit 11 controls input/output of the detection signals Sa to Sd from the 4-split photodetector 1 to/from the MIXAMP 12. The MIXAMP 12 has a positive terminal (noninverting input terminal) which receives a reference voltage Ref and has a negative terminal (inverting input terminal) which receives the detection signals Sa to Sd selectively output from the control circuit 11. The MIXAMP 12 synthesizes the detection signals Sa to Sd from the 4-split photodetector 1 and the GCA 12 and the amplifier unit 13 control a gain as appropriate to thereby output an RF signal S_{RF} from an output RFOUT.

Switching devices are provided between the photodetectors Da to Dd and the MIXAMP 12 and switched, by which the control circuit 11 selectively supplies the detection signals Sa to Sd of the photodetectors Da to Dd to the MIXAMP 12 under control.

The control circuit 11 selectively uses some or all of the detection signals Sa to Sd from the photodetector 1, in accordance with a reproduction area to generate an RF signal S_{RF} under control. The reproduction area refers to an area where the RF signal S_{RF} is generated, in this embodiment, a data portion and a header portion. The control circuit 11 selectively outputs the detection signals Sa to Sd in accordance with radius-direction distribution of signals (data and address information) recorded on a track in a reproduction area. That is, in the case of reproducing address information recorded on an inner circumferential side of a land track or groove track in accordance with the distribution of signals, the detection signals Sa and Sd of the photodetectors Da and Dd are output. In the case of reproducing address information recorded on an outer circumferential side of a land track or groove track, the detection signals Sb and Sc of the photodetectors Db and Dc are output. In the case of reproducing signals in a data portion at the center of a track, the detection signals Sa to Sd of the photodetectors Da to Dd are all output. In this way, a track is divided into plural areas based on the radius-direction distribution of signals recoded on the track in the reproduction area, and only desired ones of the detection signals Sa to Sd are output to the MIXAMP 12 in accordance with the areas.

That is, in this embodiment, in the case of reproducing the address information ID1 and ID2 of a land track or the address information ID3 and ID4 of a groove track upon reproducing a header portion, only the detection signals Sa and Sd of the photodetectors Da and Dd are supplied to the MIXAMP 12 under control. In the case of reproducing the address information ID3 and ID4 of a land track or the address information ID1 and ID2 of a groove track, only the detection signals Sb and Sc of the photodetectors Db and Dc are supplied to the MIXAMP 12 under control. Further, in the case of reproducing a data portion, all of the detection signals of the photodetectors Da to Dd are supplied under control as in the conventional circuit.

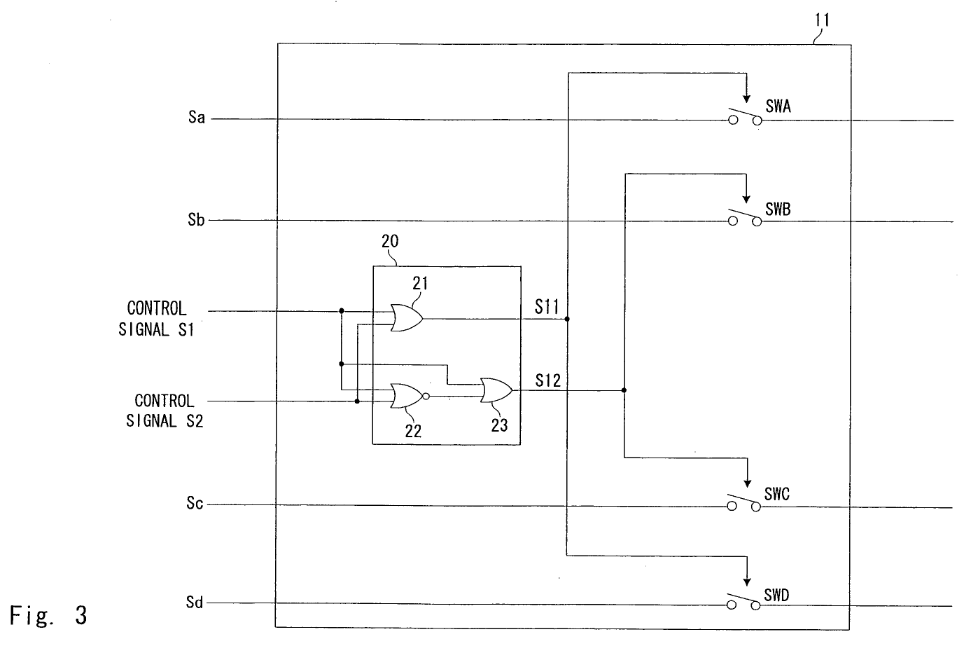

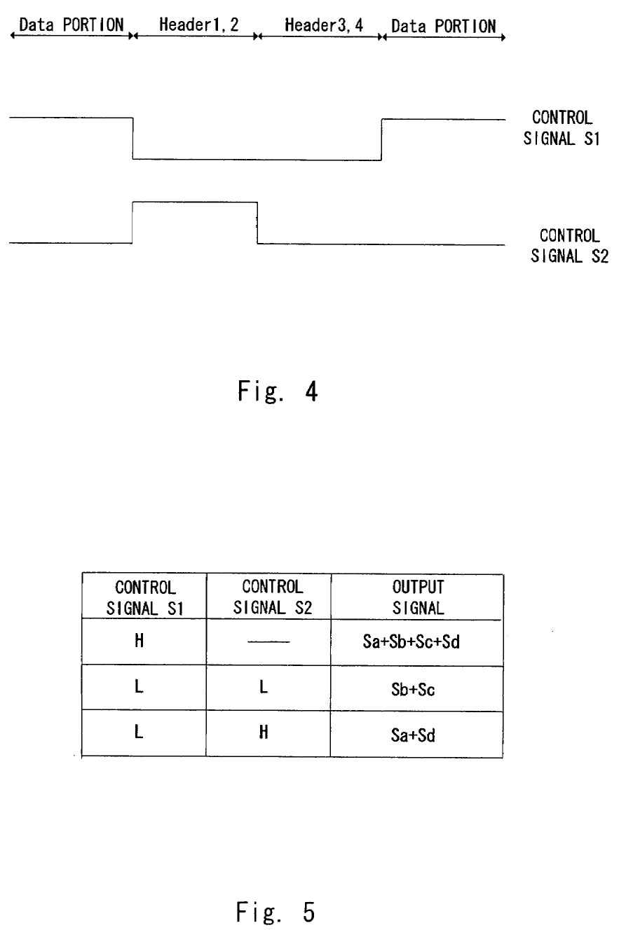

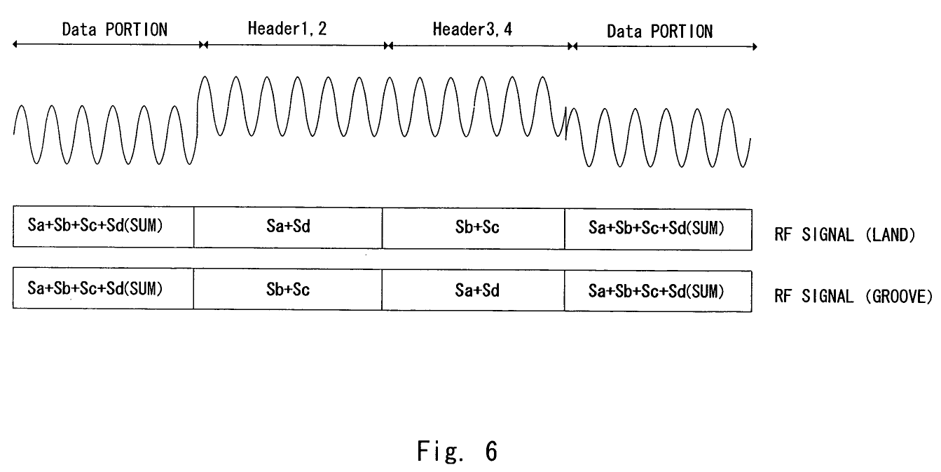

FIG. 3 shows a specific example of the control circuit 11, FIG. 4 shows a control signal used in the control circuit, FIG. 5 illustrates a detection signal selectively output from the control circuit, and FIG. 6 schematically shows an RF signal S_{RF}.

As shown in FIG. 3, the control circuit 11 includes a logic circuit unit 20 decoding the control signals S1 and S2, and switches SWA to SWD provided between the photodetectors Da to Dd and resistors connected with the MIXAMP 12. The logic circuit unit 20 includes an OR circuit 21 receiving control signals S1 and S2, a NOR circuit 22 receiving the control signals S1 and S2, and an OR circuit 23 receiving the control signals S1 and an output signal of the NOR circuit 22. In the control circuit 10, the logic circuit unit 20 decodes the control signals S1 and S2 to generate the control signals S11 and S12. Then, the control signal S11 executes on/off control of the switches SWA and SWD and the control signal S12 executes on/off control of the switches SWB and SWC.

Here, the control signals S1 and S2 as shown in FIG. 4 can be generated as follows: a CAPA address is read after inserting a disk and the controller 105 generates the signal based on the read CAPA address. The control signals S1 and S2 are used to control the switches SWA to SWD to output only a desired one of the detection signals Sa to Sd to the MIXAMP 12 for each of plural track areas divided in accordance with the radius-direction distribution of signals recoded on a track in a reproduction area as described above.

As described above, in on-track condition, the photodetectors (Da+Dd) can detect the address information ID1 and ID2 in a land, and the photodetectors (Db+Dc) can detect the address information ID3 and ID4. Further, the photodetectors (Da+Dd) can detect the address information ID3 and ID4, and the photodetectors (Da+Dc) can detect the address information ID1 and ID2 in a groove.

That is, in the case of reproducing the land, upon reproducing the address information ID1 and ID2, only the detection signals Sa and Sd of the photodetectors (Da+Dd) are required, and the detection signals Sb and Sc of the photodetectors (Db+Dc) are not required. Accordingly, only the detection signals Sa and Sd of the photodetectors (Da+Dd) are supplied to the MIXAMP 12. Further, in the case of reproducing the address information ID3 and ID4, only the detection signals Sb and Sc from the photodetectors (Db+Dc) are required, and the detection signals Sa and Sd of the photodetectors (Da+Dd) are not required. Accordingly, only the detection signals Sb and Sc of the photodetectors (Db+Dc) are supplied to the MIXAMP 12. Similar to a groove, only detection signals of photodetectors detecting the address information ID1 and ID2 are supplied to the MIXAMP under control.

To be specific, as shown in FIGS. 4 and 5, the control circuit 11 executes control such that if the control signal S1 is at high level H, all the switches SWA to SWD are turned on, and all of the detection signals Sa to Sd are supplied to the MIXAMP 12. If the control signals S1 and S2 are at low level L, only the switches SWB and SWC are turned on, and only the detection signals Sb and Sc are supplied to the MIXAMP 12. If the control signals S1 and S2 are at low level L and high level H, respectively, only the switches SWA and SWD are turned on, and only the detection signals Sa and Sd are supplied to the MIXAMP 12.

Thus, the detection signals Sa to Sd are selectively input to the MIXAMP 12 through the control circuit 11. The MIXAMP 12 adds the selectively input detection signals Sa to Sd, the subsequent GCA 13 and AMP 14 controls gain as appropriate, and an RF signal S_{RF} is output from a terminal RFO.

As shown in FIG. 6, upon reproducing a data portion, the signal (Sa+Sb+Sc+Sd) as the sum of the detection signals Sa, Sb, Sc, and Sd from the 4-split photodetectors Da, Db, Dc, and Dd is output as an RF signal S_{RF} from the output RFOUT. Further, upon reproducing a header portion in a land, the signal (Sa+Sd) is output as an RF signal S_{RF} in a section recording the address information ID1 and ID2, and the signal (Sb+Sc) is output as an RF signal S_{RF} in a section recording the information ID3 and ID4. On the other hand, upon generating a header portion in a groove, the signal (Sb+Sc) is output as an RF signal S_{RF} in a section recording the information ID1 and ID2, and the signal (Sa+Sc) is output as an RF signal S_{RF} in a section recording the information ID3 and ID4.

Incidentally, in this embodiment, the control signals S1 and S2 are used to control the four switches. However, the present invention is not limited to the above control circuit and control signal, and other control circuits and control signals may be used insofar as, among the detection signals Sa to Sd, the signal (Sa+Sd) as the sum of the detection signals of the photodetectors on one side of the 4-split photodetector 1 as split along the track direction, the signal (Sb+Sc) as the sum of the detection signals of the photodetectors on the other side, and the signal (Sa+Sb+Sc+Sd) as the sum of all detection signals can be selectively output.

In this embodiment, in the DVD-RAM-compatible optical disk device, the control circuit 11 provided at an input stage of the MIXAMP 12 selects the detection signals A to D to be output to the terminal RFO. Hence, as the RF signal S_{RF}, one of the three signals, the signal (Sa+Sb+Sc+Sd), the signal (Sa+Sd), and the signal (Sb+Sd) is selectively output.

Then, in a reproduction area including a data portion and a header portion, only desired ones of the detection signals Sa to Sd, not all the detection signals Sa to Sd, are selectively output in accordance with the radius-direction distribution of signals on a track, as the RF signal S_{RF}. Thus, upon reproducing the data portion and the header portion, only requisite ones can be selected to obtain the optimum RF signal S_{RF}. More specifically, the signal (Sa+Sd) or (Sb+Sc) is selected in a header portion to thereby reproduce an RF signal S_{RF} not influenced by a crosstalk signal from an adjacent track. Thus, an error rate can be improved.

This embodiment describes the 4-split photodetector by way of example. Even if a photodetector is split into two along a track direction as a 2-split photodetector, similar effects can be obtained. Further, in this embodiment, upon reproducing address information, only desired ones of the detection signals from the photodetector are used to generate a reproduction signal, but the present invention is not limited thereto. Only desired ones of the signals from the photodetectors are used in accordance with a reproduction area to obtain an RF signal S_{RF}, thereby making it possible to suppress unnecessary noise components superimposed on the RF signal.

It is apparent that the present invention is not limited to the above embodiment that may be modified and changed without departing from the scope and spirit of the invention.

What is claimed is:

1. An optical disk device, comprising:
an irradiating unit irradiating an optical disk with laser light;
a photodetector split into at least two along a track direction of the optical disk and converting return light from the optical disk into an electric signal to output a detection signal; and
a reproduction signal generating unit generating the reproduction signal by selectively using a part or all of detection signals from the photodetector in accordance with a reproduction area.

2. The optical disk device according to claim 1, wherein the reproduction signal generating unit uses a part of the detection signals from the photodetector to generate the reproduction signal upon generating address information.

3. The optical disk device according to claim 1, wherein the reproduction signal generating unit selectively uses a first detection signal from one of the at least two photodetectors split along the track direction, a second detection signal from the other photodetector, or a signal as the sum of the first and second detection signals to generate an RF signal.

4. The optical disk device according to claim 2, wherein the reproduction signal generating unit selectively uses a first detection signal from one of the at least two photodetectors split along the track direction, a second detection signal from the other photodetector, or a signal as the sum of the first and second detection signals to generate an RF signal.

5. The optical disk device according to claim 3, wherein the reproduction signal generating unit includes a control unit selectively outputting the first detection signal or the second detection signal from the photodetectors, and
the control unit selectively outputs the first detection signal, the second detection signal, or the signal as the sum of the first and second detection signals at a predetermined timing.

6. The optical disk device according to claim 3, wherein the optical disk includes a header portion where address information is recoded and a data portion where user data is recoded in a land or a groove, and
the reproduction signal generating unit generates a reproduction signal based on the signal as the sum of the first detection signal and the second detection signal upon reproducing the data portion, and generates a reproduction signal based on the first detection signal or the second detection signal upon reproducing the header portion.

7. The optical disk device according to claim 4, wherein the optical disk includes a header portion where address information is recoded and a data portion where user data is recoded in a land or a groove, and
the reproduction signal generating unit generates a reproduction signal based on the signal as the sum of the first detection signal and the second detection signal upon reproducing the data portion, and generates a reproduction signal based on the first detection signal or the second detection signal upon reproducing the header portion.

8. The optical disk device according to claim 5, wherein the optical disk includes a header portion where address information is recoded and a data portion where user data is recoded in a land or a groove, and
the reproduction signal generating unit generates a reproduction signal based on the signal as the sum of the first detection signal and the second detection signal upon reproducing the data portion, and generates a reproduction signal based on the first detection signal or the second detection signal upon reproducing the header portion.

9. A playback method of an optical disk device comprising:
irradiating an optical disk with laser light;
converting return light from the optical disk into an electric signal to output a detection signal by a photodetector split into at least two along a track direction; and
generating the reproduction signal by selectively using a part or all of detection signals from the photodetector in accordance with a reproduction area.
